(19) United States
(12) Patent Application Publication
(10) Pub. No.: US 2003/0053900 A1
(43) Pub. Date: Mar. 20, 2003

(54) Trailer having ramp movable between vertically displaced loading positions

(76) Inventor: Richard A. Neville, Kingman, KS (US)

Correspondence Address: John R. Flanagan, FLANAGAN & FLANAGAN, P.O. Box 11300, Jackson Hole, WY, 83002, US

(21) Appl. No.: 09/954,688

(22) Filed: Sep. 14, 2001

(51) Int. Cl. B60P 1/43; B65G 69/28

(52) U.S. Cl. 414/537; 14/71.1; 14/71.3

(57) ABSTRACT

A cargo carrying trailer includes a mobile body having a floor and upright wall structure mounted upon the floor such that the floor and wall structure together define at least one load compartment for hauling cargo therein. The floor has an opening extending from adjacent to a peripheral portion of the floor to an inwardly spaced location. The trailer also includes a ramp disposed in the floor opening and an arrangement for converting the ramp relative to the floor between vertically displaced raised and lowered positions to permit loading cargo over the ramp to the compartment from locations at different elevations. In the raised position the ramp extends substantially coplanar with the floor and thus at an elevated location, whereas in the lowered position the ramp has one end disposed adjacent to the floor and an opposite end disposed below the one end of the ramp and thus below the elevated location.

### BACKGROUND OF THE INVENTION

1. Field of the Invention

The present invention generally relates to a trailers for hauling livestock and the like and, more particularly, is concerned with a trailer having a ramp being movable between vertically displaced loading positions for loading livestock either directly from ground level or from a loading platform or chute into the trailer. The term “trailer” is used herein to broadly include any truck bed or the like.

2. Description of the Prior Art

Typically, a trailer used in hauling cargo, such as livestock and the like, includes a mobile frame having an elongated platform or floor and one or more sets of wheel and axle assemblies arranged in tandem relationship to one another and underlying and supporting a rear portion of the platform or floor thereabove. The trailer also includes an upright wall structure mounted in an upstanding relationship upon and along the periphery of the floor of the mobile frame so as to form at least one compartment therewith for containing the cargo on the trailer. Further, the trailer typically has one or more rear doors or gates which are opened to facilitate loading the cargo onto the floor of the trailer from ground level by use of a conventional inclined loading chute. The doors or gates typically are either pivoted to the side or are pulled upward to open the rear end of the trailer. It is also known to provide a loading ramp for a trailer that pulls out from a storage position under the trailer floor so as to assume an inclined position in which the ramp extends from the rear end of the trailer.

While these prior art load carrying trailers appear to be satisfactory in use for the specific purposes for which they were designed, there is a need for more improvement thereof.

### SUMMARY OF THE INVENTION

The present invention provides a trailer having a ramp designed to satisfy the aforementioned need. The ramp of the trailer of the present invention is movable between vertically displaced loading positions for loading cargo, such as livestock, either directly from ground level or from a loading chute into the trailer. The ramp preferably is pivotally mounted within an opening in a rear corner of the floor such that it can be positioned to serve as a horizontally extending portion of the floor when it is desired to load cargo onto the floor from a normal loading platform or chute or alternatively it can be positioned to serve as an inclined ramp structure facilitating the loading of cargo directly from ground level without using a loading chute.

Accordingly, the present invention is directed to a cargo carrying trailer which comprises: (a) a mobile body having a floor and an upright wall structure mounted in an upstanding relationship upon and along a periphery of the floor such that the floor and the wall structure together define at least one load compartment for hauling cargo therein, the floor having an opening defined therein extending from adjacent to a portion of the periphery of the floor to a location spaced inwardly from the periphery of the floor; (b) a ramp disposed in the opening of the floor; and (c) an arrangement for converting the ramp relative to the floor between vertically displaced raised and lowered positions to permit loading cargo over the ramp to the compartment from locations at different elevations relative to the floor. More particularly, in the raised position the ramp preferably extends at a level substantially coplanar with and adjacent to the floor to permit loading of cargo over the ramp to the compartment from an elevated location above ground level. In the lowered position the ramp preferably has one end disposed adjacent to the floor and an opposite end disposed at a level below the one end of the ramp and adjacent to ground level to permit loading of cargo over the ramp to the compartment from the ground level below the elevated location.

These and other features and advantages of the present invention will become apparent to those skilled in the art upon a reading of the following detailed description when taken in conjunction with the drawings wherein there is shown and described an illustrative embodiment of the invention.

### BRIEF DESCRIPTION OF THE DRAWINGS

In the following detailed description, reference will be made to the attached drawings in which:

FIG. 1 is a side elevational view of a cargo carrying trailer having a pivotal ramp in accordance with the present invention.

FIG. 2 is an end elevational view of the trailer of FIG. 1, showing the ramp in a raised position at the level of a floor of the trailer.

FIG. 3 is another end elevational view of the trailer of FIG. 1, showing the ramp in a lowered position in which it extends downward adjacent to ground level.

FIG. 4 is an enlarged fragmentary side elevational view of the rear end of the trailer showing the ramp in the raised position of FIG. 2.

FIG. 5 is an enlarged fragmentary side elevational view of the rear end of the trailer showing the ramp in the lowered position of FIG. 3.

### DETAILED DESCRIPTION OF THE INVENTION

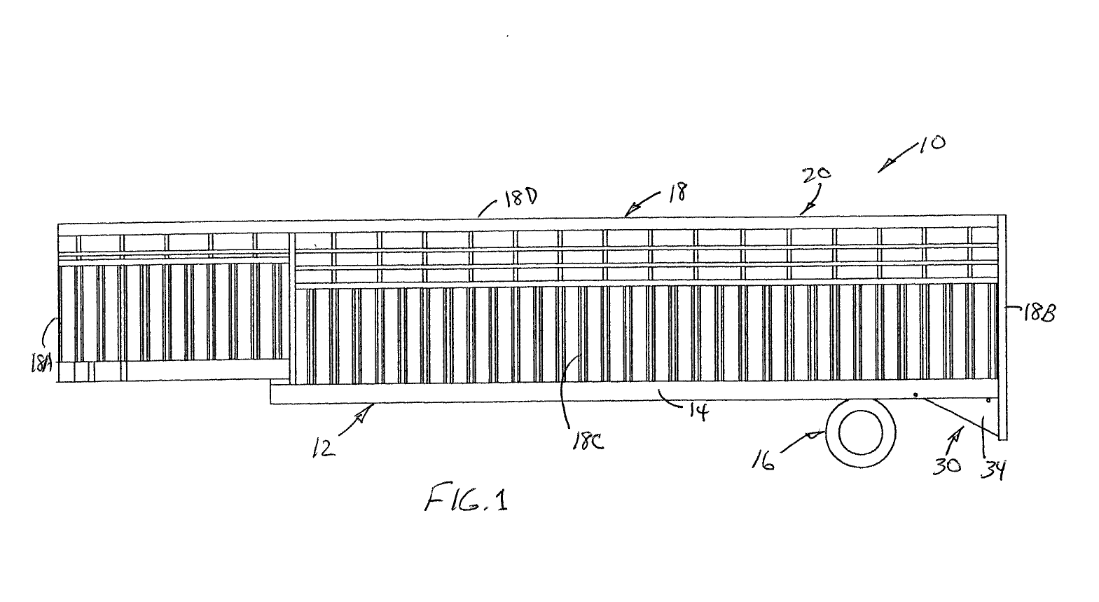

Referring to the drawings and particularly to FIGS. 1-3, there is illustrated a trailer, generally designated 10, in accordance with the present invention for carrying cargo, such as livestock or the like. Basically, the trailer 10 includes a mobile body 12 having an elongated deck or floor 14, one or more sets of wheel and axle assemblies 16 arranged in tandem relationship with one another below and supporting a rear portion of the floor 14, and an upright wall structure 18 fixedly mounted in an upstanding relationship upon and along the periphery of the floor 14 of the mobile body 12. The wall structure 18 includes a front end portion 18A, a rear end portion 18B and a pair of opposite side portions 18C extending between and interconnecting the front and rear end portions 18A, 18B. Also, the wall structure 18 may have a top portion 18D overlying and connected with the front and rear end portions 18A, 18B and opposite side portions 18C so as to form an enclosure 20 defining at least one load compartment for containing the cargo on the trailer 10. Further, the trailer 10 has a rear door or gate 22 which can be opened in order to load the cargo onto the floor 14 of the trailer 10 from an elevated platform (not shown) or by use of a conventional inclined loading chute (not shown). As used hereafter, it will be understood that the term “chute” is meant to include either an elevated platform or an inclined loading chute. The rear gate 22 can either be mounted to pivot horizontally toward or away from one of the opposite side portions 18C or moved vertically toward or away from the top portion 18D of the wall structure 18 to open or close a passage 24 to the enclosure 20 and load compartment therein, the passage 24 preferably being located in the rear end portion 18B of the wall structure 18 of the trailer 10.

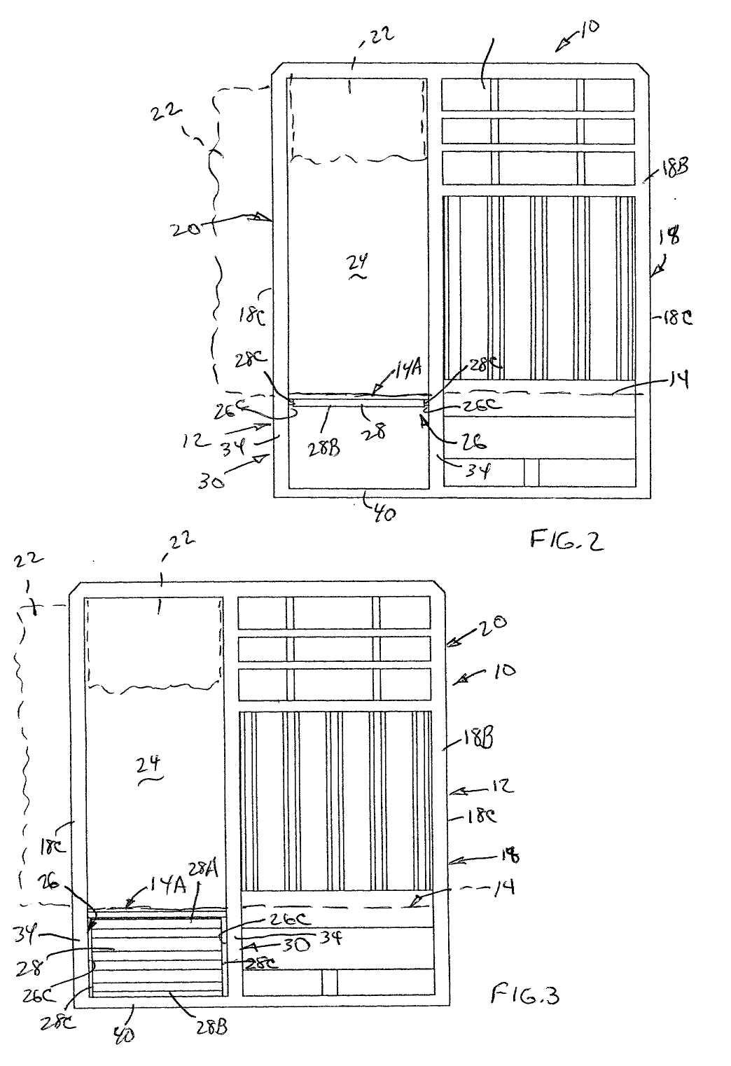

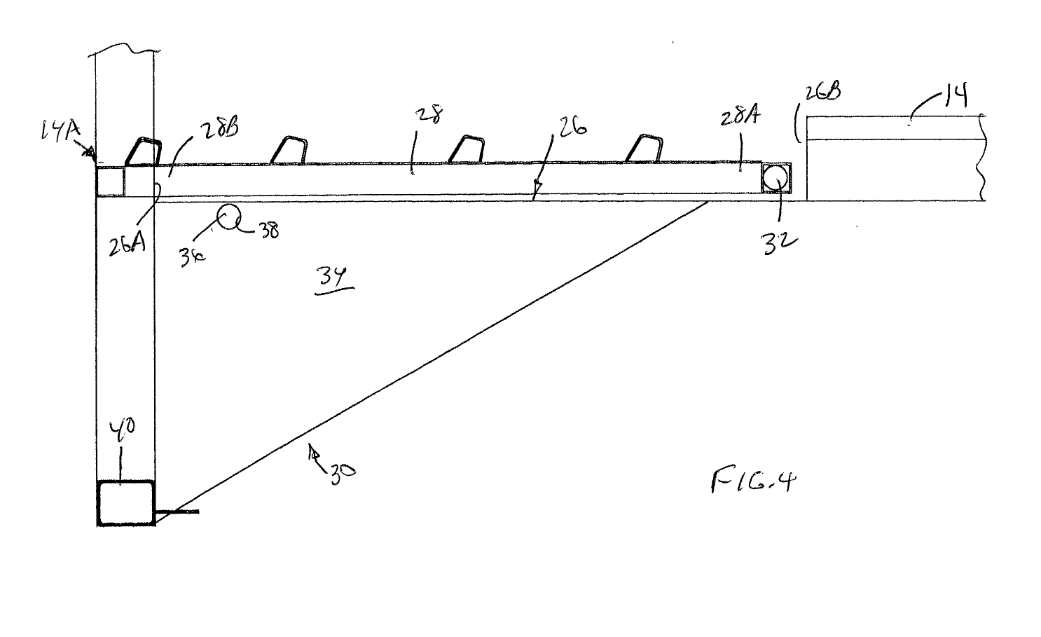

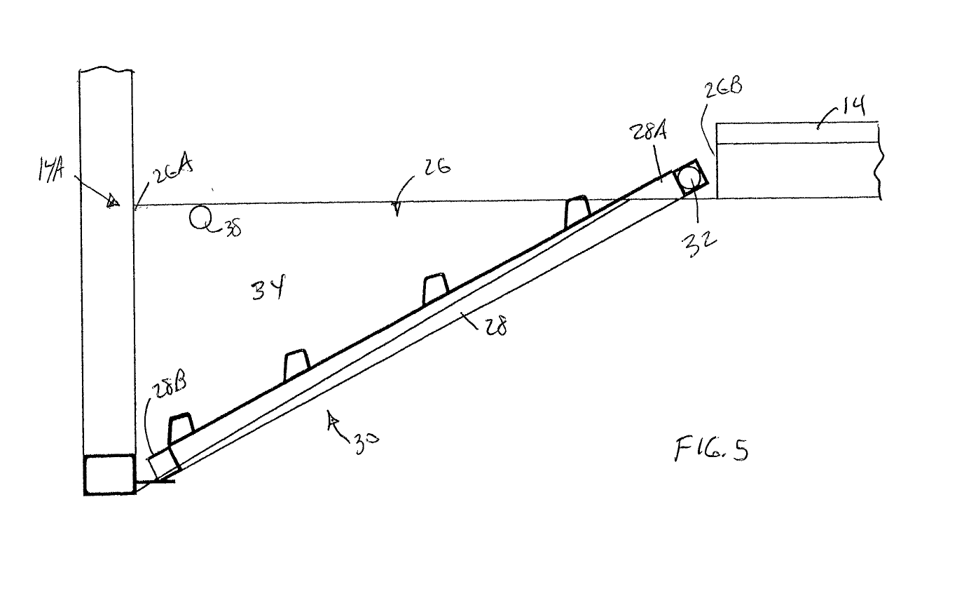

Referring to FIGS. 1-5, in accordance with the features of the present invention, the trailer 10 further includes an opening 26 defined in the floor 14, a ramp 28 disposed adjacent to the opening 26, and an arrangement 30 for supporting the ramp at, and pivotally moving the ramp 28 relative to the floor 14 between, vertically displaced raised and lowered positions to permit loading cargo over the ramp 28 to the compartment from locations at the different elevations relative to the floor 14, namely between a generally raised position, as seen in FIGS. 2 and 4, and a lowered position, as seen in FIGS. 3 and 5. The opening 26 preferably is defined in a rear corner portion 14A of the floor 14 so as to extend from an outer end 26A located adjacent to a portion 14B of the periphery of the floor 14 to an opposite inner end 26B spaced inwardly from the periphery of the floor 14. Both the opening 26 and ramp 28 have substantially rectangular configurations. In the raised position, the ramp 28 substantially covers or fills and thus closes the opening 26 in the floor 14 by extending generally horizontally and within the plane and perimeter of the opening 26 of the floor 14 for facilitating the loading of cargo, such as livestock, into the load compartment of the enclosure 22 from the end of the chute disposed substantially at the level of the trailer floor 14. In the lowered position, the ramp 26 uncovers and thus opens the opening 26 in the floor 14 by extending rearwardly and downwardly from an inner or forward end 26A of the opening 26 toward the ground and below the floor 14 for facilitating the loading of the cargo, such as livestock, into the load compartment of the enclosure 22 from the ground level.

More particularly, the ramp 28 has opposite inner and outer ends 28A, 28B. The arrangement 30 includes a transverse member 32 mounted to the mobile body 12 adjacent to the inner end 26B of the opening 26 in the floor 14 and pivotally mounting the inner end 28A of the ramp 28 such that the ramp 28 can undergo pivotal movement between the vertically displaced raised and lowered positions. The arrangement 30 also includes a pair of side brace members 34 fixedly attached to the trailer body 12 and extending downward from the floor 14 thereof along opposite sides 26C of the opening 26 therein and along opposite sides 28C of the ramp 28. The arrangement 30 further includes an upper member 36 disposed adjacent to the floor 14 and extending between the side brace members 34, and through holes 38 therein, so as to support the ramp 28 adjacent its outer end 28B at the raised position, as seen in FIG. 4. The upper member 36 is removable from the holes 38 of and from between the side brace members 34 so as to allow conversion and movement of the ramp to the lowered position of FIG. 5. The arrangement 30 still further includes a lower member 40 disposed adjacent to ground level and extending between and fixedly connected to the side brace members 34 so as to support the ramp 28 at the outer end 28B thereof at the lowered position.

It is thought that the present invention and its advantages will be understood from the foregoing description and it will be apparent that various changes may be made thereto without departing from the spirit and scope of the invention or sacrificing all of its material advantages, the form hereinbefore described being merely preferred or exemplary embodiment thereof.

I claim:

1. A cargo carrying trailer, comprising:
(a) a mobile body having a floor and an upright wall structure mounted in an upstanding relationship upon and along a periphery of said floor such that said floor and wall structure together define at least one load compartment for hauling cargo therein, said floor having an opening defined therein extending from an outer end of said opening located adjacent to a portion of said periphery of said floor to an opposite inner end of said opening spaced inwardly from said periphery of said floor;
(b) a ramp disposed in said opening of said floor; and
(c) means for converting said ramp relative to said floor between vertically displaced raised and lowered positions to permit loading cargo over said ramp to said compartment from locations at different elevations relative to said floor.

2. The trailer of claim 1 wherein said ramp, in said raised position, extends at a level substantially coplanar with and adjacent to the floor to permit loading of cargo over the ramp to the compartment from an elevated location above ground level.

3. The trailer of claim 1 wherein said ramp, in said lowered position, has one end disposed adjacent to said floor and an opposite end disposed at a level below said one end of said ramp and adjacent to a ground level to permit loading of cargo over said ramp to said compartment from the ground level.

4. The trailer of claim 1 wherein:
said ramp has opposite inner and outer ends; and
said converting means includes a transverse member mounted to said mobile body adjacent to said inner end of said opening in said floor and pivotally mounting said inner end of said ramp such that said ramp can undergo pivotal movement between said vertically displaced raised and lowered positions.

5. The trailer of claim 1 wherein said converting means includes a pair of side brace members fixedly attached to said trailer body and extending downward from said floor thereof along opposite sides of said opening therein and along opposite sides of said ramp.

6. The trailer of claim 5 wherein said converting means also includes an upper member disposed adjacent to said floor and extending between said side brace members so as to support said ramp at said raised position, said upper member being removable from between said side brace members so as to allow conversion of said ramp to said lowered position.

7. The trailer of claim 6 wherein said converting means further includes a lower member disposed adjacent to ground level and extending between said side brace members so as to support said ramp at said lowered position.

8. The trailer of claim 1 wherein said opening is formed at a rear portion of said floor.

9. The trailer of claim 1 wherein said opening is formed at a rear corner of said floor.

10. The trailer of claim 1 wherein said wall structure has a passage defined therein and located above said outer end of said opening in said floor.

11. The trailer of claim 10 further comprising:
a gate mounted to said wall structure for undergoing movement between opened and closed positions relative said passage for opening and closing said load compartment of said mobile body.

12. A cargo carrying trailer, comprising:
(a) a mobile body having a floor and an upright wall structure mounted in an upstanding relationship upon and along a periphery of said floor such that said floor and wall structure together define at least one load compartment for hauling cargo therein, said floor having an opening formed at a rear portion of said floor extending from an outer end of said opening located adjacent to a portion of said periphery of said floor to an opposite inner end of said opening spaced inwardly from said periphery of said floor;
(b) a ramp disposed in said opening of said floor; and
(c) an arrangement for supporting said ramp at, and pivotally moving said ramp relative to said floor between, vertically displaced raised and lowered positions to permit loading cargo over said ramp to said compartment from locations at different elevations relative to said floor.

13. The trailer of claim 12 wherein said ramp, in said raised position, extends at a level substantially coplanar with and adjacent to the floor to permit loading of cargo over the ramp to the compartment from an elevated location above ground level.

14. The trailer of claim 12 wherein said ramp, in said lowered position, has one end disposed adjacent to said floor and an opposite end disposed at a level below said one end of said ramp and adjacent to a ground level to permit loading of cargo over said ramp to said compartment from the ground level.

15. The trailer of claim 12 wherein:
said ramp has opposite inner and outer ends; and
said ramp supporting and pivotally moving arrangement includes a transverse member mounted to said mobile body adjacent to said inner end of said opening in said floor and pivotally mounting said inner end of said ramp such that said ramp can undergo pivotal movement between said vertically displaced raised and lowered positions.

16. The trailer of claim 12 wherein said ramp supporting and pivotally moving arrangement includes a pair of side brace members fixedly attached to said trailer body and extending downward from said floor thereof along opposite sides of said opening therein and along opposite sides of said ramp.

17. The trailer of claim 16 wherein said ramp supporting and pivotally moving arrangement also includes an upper member disposed adjacent to said floor and extending between said side brace members so as to support said ramp at said raised position, said upper member being removable from between said side brace members so as to allow conversion of said ramp to said lowered position.

18. The trailer of claim 17 wherein said ramp supporting and pivotally moving arrangement further includes a lower member disposed adjacent to ground level and extending between said side brace members so as to support said ramp at said lowered position.

19. The trailer of claim 12 wherein said wall structure has a passage defined therein and located above said outer end of said opening in said floor.

20. The trailer of claim 19 further comprising:
a gate mounted to said wall structure for undergoing movement between opened and closed positions relative said passage for opening and closing said load compartment of said mobile body.
